(19) United States
(12) Patent Application Publication
(10) Pub. No.: US 2008/0315570 A1
(43) Pub. Date: Dec. 25, 2008

(54) Reduced Cost Master/Slave Trailer Landing Gear Apparatus

(75) Inventor: Bob G. Baxter, Warrenton, MO (US)

Correspondence Address: THOMPSON COBURN, LLP, ONE US BANK PLAZA, SUITE 3500, ST LOUIS, MO, 63101, US

(73) Assignee: BAXTER PROPERTIES, LLC, Warrenton, MO (US)

(21) Appl. No.: 11/765,209

(22) Filed: Jun. 19, 2007

(51) Int. Cl. B60S 9/08; B60S 9/04; B60S 9/06

(52) U.S. Cl. 280/766.1

(57) ABSTRACT

A landing gear assembly that supports the front end of a truck trailer when the trailer is not being pulled by a truck has a gearing mechanism that provides a two-speed operation for raising and lowering the legs of the landing gear assembly, where the gearing mechanism is entirely contained inside the leg housings of the landing gear assembly and has a simplified, two shaft, five gear construction that reduces the manufacturing cost of the assembly.

### BACKGROUND OF THE INVENTION

(1) Field of the Invention

This invention pertains to a landing gear apparatus that supports the front end of a trailer when the trailer is not being pulled by a truck. In particular, the present invention pertains to a landing gear apparatus having a gearing transmission of a simplified, reduced cost construction that is entirely contained inside the leg housing enclosing the landing gear assembly.

(2) Description of the Related Art

Many of the different types of trailers that are towed by trucks are connected to the trucks by a releasable coupling such as a gooseneck coupling or a fifth-wheel coupling. When the trailer is released from the truck and is no longer supported by the truck at the forward end of the trailer, a landing gear apparatus is often used to support the trailer at the trailer forward end, maintaining a generally horizontal positioning of the trailer.

The typical landing gear apparatus is attached to the underside of the trailer adjacent the truck coupling at the forward end of the trailer. The apparatus can have a single leg housing that is attached at a forward end of a trailer for example a goose neck trailer, but often includes a pair of vertically oriented leg housings positioned adjacent opposite sides of the trailer. A vertical leg column is mounted in each housing. A gear mechanism on each leg is selectively operated to lower the columns from the leg housings, or raise the columns on the leg housings. The gear mechanisms of the two leg housings are connected together by a shaft assembly that extends across the underside of the trailer between the two leg housings. A hand crank is connected to the shaft assembly at one side of the trailer. Selectively rotating the hand crank in opposite directions lowers the pair of leg columns until the columns contact the ground and support the trailer forward end when the trailer is being uncoupled from the truck, or raise the pair of columns when the trailer has been connected to a truck and is ready for towing.

Many prior art landing gear assemblies have two-speed gear mechanisms that enable the columns of the landing gear assembly to be lowered and raised at different speeds or at different rates. The input shaft of the landing gear assembly is moved axially inwardly and outwardly relative to the trailer to shift the assembly between the two speeds. For example, the landing gear assembly input shaft can be pushed inwardly by the truck operator to shift to a high speed gear. Rotation of the input shaft by the hand crank will then cause the columns of the landing gear assembly legs to be lowered or raised at a faster rate. This enables the leg columns of the landing gear assembly to be lowered quickly until they come into engagement with the ground beneath the trailer when it is desired to uncouple the trailer from the truck. The gear mechanism of the landing gear assembly is then shifted to a low gear ratio by pushing axially on the crank, moving the input shaft axially inwardly toward the trailer assembly. When shifted to the low gear ratio, more power is transferred to the leg columns by the reduction gearing of the landing gear assembly gear mechanism. For each rotation of the crank, the leg columns are lowered at a slower rate, but more power is transferred to the columns enabling the landing gear assembly to lift the trailer from the truck when uncoupling the trailer from the truck.

Prior art landing gear assemblies that include gear mechanisms that provide a high-speed, low-torque operation or a low-speed, high-torque operation typically include a separate casing or housing for the gear mechanism. The separate casing is needed to contain the many gears and clutching mechanisms typically employed in the prior art gear mechanisms. The gear mechanism housing is typically attached to a side of one of the leg housings of the landing gear assembly. In some prior art landing gear assemblies, gear mechanism housings are attached to the sides of both leg housings.

The positioning of the gear mechanism housings on the sides of the leg housings at times makes it difficult to attach a landing gear assembly to a particular construction of a truck trailer. The need to provide a separate gear mechanism housing in addition to the leg housing increases the costs involved in manufacturing the landing gear assembly. Furthermore, positioning of the gear mechanism housing relative to the leg housing may limit the landing gear assembly for attachment only to the outsides of frame members of the trailer, or to the insides of frame members of the trailer.

Furthermore, as stated earlier, the prior art gear mechanisms used on trailer landing gear assemblies typically included an elaborate arrangement of gears and clutches that enable the gear mechanism to shift between two speeds and two torques simply by axially moving the input shaft between two axially spaced positions. The increased numbers of gears, countershafts, and clutching mechanisms in the prior art gear mechanisms contribute to the overall cost of manufacturing the gear mechanisms. Thus, the greater number of gears, countershafts, and clutch mechanisms required by a gear mechanism, the greater the cost involved in manufacturing the gear mechanism.

### SUMMARY OF THE INVENTION

The landing gear assembly of the present invention overcomes the above-discussed disadvantages of prior art landing gear assemblies by providing a landing gear assembly with a two-speed or two-torque gear mechanism that has a simplified, reduced cost construction and is entirely contained in a leg housing of the landing gear assembly. This enables the landing gear assembly of the present invention to be economically manufactured and to be readily used with various different types of trailer configurations.

The landing gear assembly is provided in a master leg and slave leg arrangement, where the power for lifting and lowering the truck trailer is provided by the master leg, as is conventional. An input shaft enters one side of the leg housing of the master leg and an output shaft exits the opposite side of the leg housing. The output shaft extends across the landing gear assembly to drive a bevel gear mechanism in the slave leg. The bevel gear mechanism extends and retracts the length of the slave leg to match the extension and retraction of the master leg. The novel gearing mechanism of the invention is comprised of only an input shaft and an output shaft, and does not require any other additional shafts for supporting gearing of the mechanism. Reducing the number of shafts required by the gearing mechanism reduces the cost of manufacturing the gearing mechanism.

Conventional actuator screw and nut assemblies are provided inside the leg housings. Each actuator includes an actuator input gear that drives a screw of the actuator that in turn extends the leg column from the leg housing and retracts the leg column into the leg housing, depending on the direction of rotation. The gear mechanism of the invention drives both the output shaft that is operatively connected to the slave leg and the actuator input gear at two different rates of rotation. The gear mechanism is shifted between the two different rates of rotation by manually moving the input shaft axially between first and second positions of the input shaft relative to the leg housing. The gear mechanism of the invention is entirely contained within the opposite side walls of the leg housing that contain the actuator assembly.

The gear mechanism of the invention includes a first, high-speed input gear and a second, low-speed input gear that are both mounted on the input shaft. The first and second input gears are mounted for independent rotation on the input shaft. The input shaft is provided with a key that engages the first input gear to the input shaft in the first position of the input shaft, and engages the second input gear to the input shaft in the second position of the input shaft. When the first input gear is engaged to the input shaft, the second input gear is free to rotate relative to the first input gear and the input shaft. When a second input gear is engaged to the input shaft, the first input gear is free to rotate relative to the second input gear and the input shaft.

The gear mechanism of the invention also includes an output gear that is secured stationary to the output shaft inside the leg housing, a first driven gear that is secured stationary to the output shaft inside the leg housing, and a second driven gear that is secured stationary to the output shaft inside the leg housing. In the preferred embodiment, the output gear, the first driven gear, and the second driven gear are all part of a one-piece gear element that is secured to the output shaft. This construction of the gear element further reduces the manufacturing cost of the landing gear apparatus. The output gear meshes directly with the actuator input gear. The first driven gear meshes directly with the first drive gear and has a fewer number of gear teeth than the first drive gear. Thus, each rotation of the first drive gear with the input shaft drives the first driven gear and the output shaft in more than one rotation. The second driven gear meshes directly with the second drive gear and has a greater number of gear teeth than the second drive gear. Thus, each rotation of the input shaft and the second drive gear rotates the second driven gear and the output shaft in less than one rotation. However, the second drive gear imparts more torque to the second driven gear than does the first drive gear to the first driven gear.

A clutch mechanism in the form of a shear pin secured to the input shaft selectively secures the first drive gear or the second drive gear to the input shaft for rotation with the input shaft. When the first drive gear is secured to the input shaft, the second drive gear rotates freely on the input shaft. When the second drive gear is secured to the input shaft, the first drive gear rotates freely on the input shaft.

Moving the input shaft axially inwardly into the leg housing secures the first drive gear to the input shaft. Rotation of the input shaft with the first drive gear secured to the input shaft drives the first driven gear on the output shaft in rotation and in turn causes the actuator assembly to lower and raise the leg column relative to the leg housing at a faster rate, depending on which direction the input shaft is turned by the manual crank connected to the input shaft. Pulling the input shaft axially outwardly secures the second drive gear to the input shaft. Rotating the input shaft with the second drive gear secured to the input shaft causes the second drive gear to drive the second driven gear on the output shaft, which in turn drives the actuator assembly to raise and lower the leg column relative to the leg housing at a slower rate, depending on the direction of rotation of the input shaft by the manual crank. The gearing ratio of the second drive gear and the second driven gear, although moving the leg column more slowly relative to the leg housing, imparts greater torque to the output shaft and the actuator assembly, and thereby makes it easier to lift the weight of the trailer.

If so desired, the landing gear apparatus can be used as a single lifting apparatus for a trailer, for example a goose neck trailer. The landing gear apparatus can also be connected to a second slave leg by connecting the output shaft of the apparatus to an input shaft of the second leg.

The novel gearing arrangement of the invention allows the landing gear apparatus to be constructed more compactly in a single leg housing, and more cost efficiently. The simplified gearing mechanism enables the input shaft, the output shaft, and a screw shaft of the actuator assembly to be positioned in a single plane, with these shafts being the only shafts contained in the leg housing. The reduced number of gears required by the gearing mechanism also reduces the cost of manufacturing the apparatus. Furthermore, the novel gear mechanism of the invention provides a landing gear apparatus with a two-speed operation where the gear mechanism is entirely contained in the landing gear assembly leg housing, removing the need for separate casing or housing for the gear mechanism.

### BRIEF DESCRIPTION OF THE DRAWINGS

Further features of the invention are set forth in the following detailed description of the preferred embodiment of the invention, and in the drawing figures.

FIG. 1 is a front perspective view of a pair of landing gear assembly legs prepared for a conventional mounting to the front of a trailer, the legs being viewed from the perspective at the front of the trailer.

FIG. 2 is a front elevation view of the pair of legs shown in FIG. 1.

FIG. 3 is a side elevation view of the pair of legs of FIG. 1 from the right side of FIG. 1.

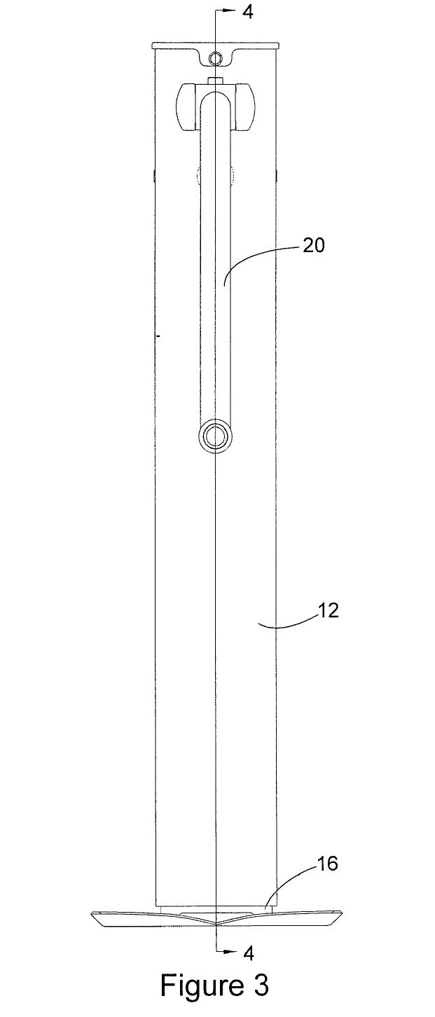

FIG. 4 is a front elevation cross-section view of the pair of legs of FIG. 1 in the plane of line 4-4 of FIG. 3.

FIG. 5 is a partial, enlarged cross-section view of the gearing mechanism shown in FIG. 4 with the gearing mechanism shifted to the first, high speed, low torque gear ratio.

FIG. 6 is a view similar to FIG. 5, but with the gearing mechanism shifted to the second, low speed, high torque gear ratio.

FIG. 7 is a perspective view of the gears of the gearing mechanism removed from the leg housing.

FIG. 8 is a side elevation view of the leg housing of the slave leg shown to the left in FIG. 1.

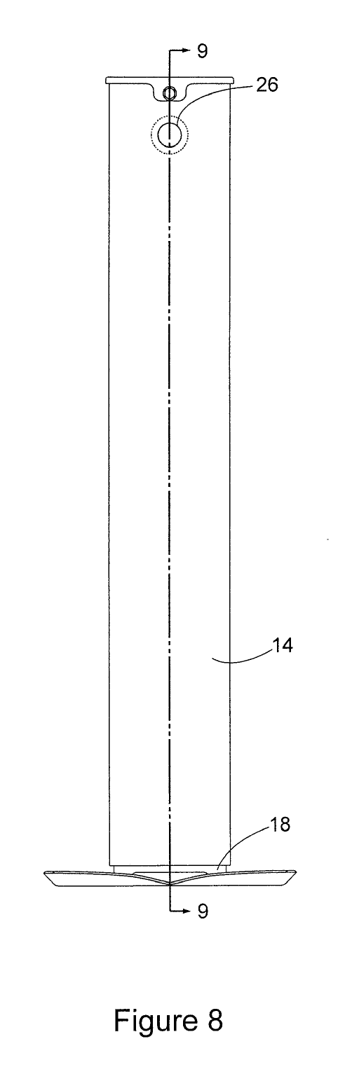

FIG. 9 is a cross-section view of the slave leg of FIG. 8 in the plane of line 9-9 of FIG. 8.

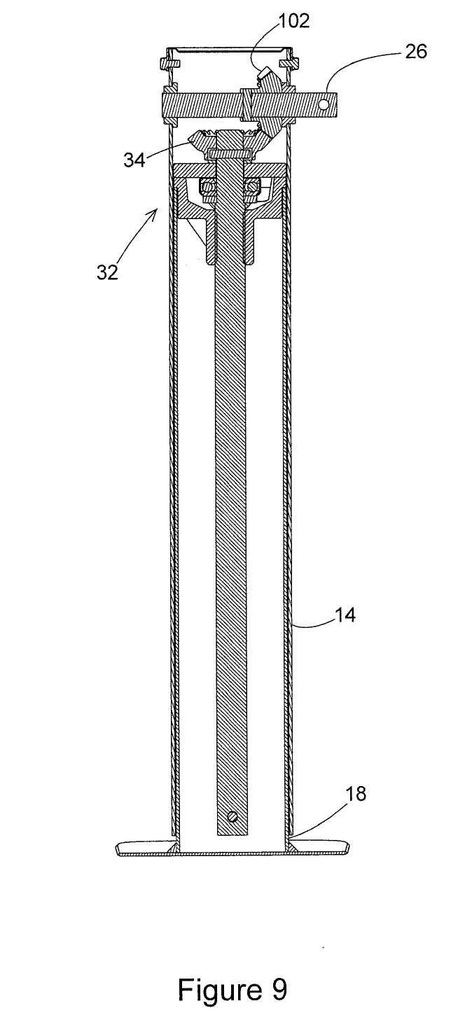

### DETAILED DESCRIPTION OF THE PREFERRED EMBODIMENT

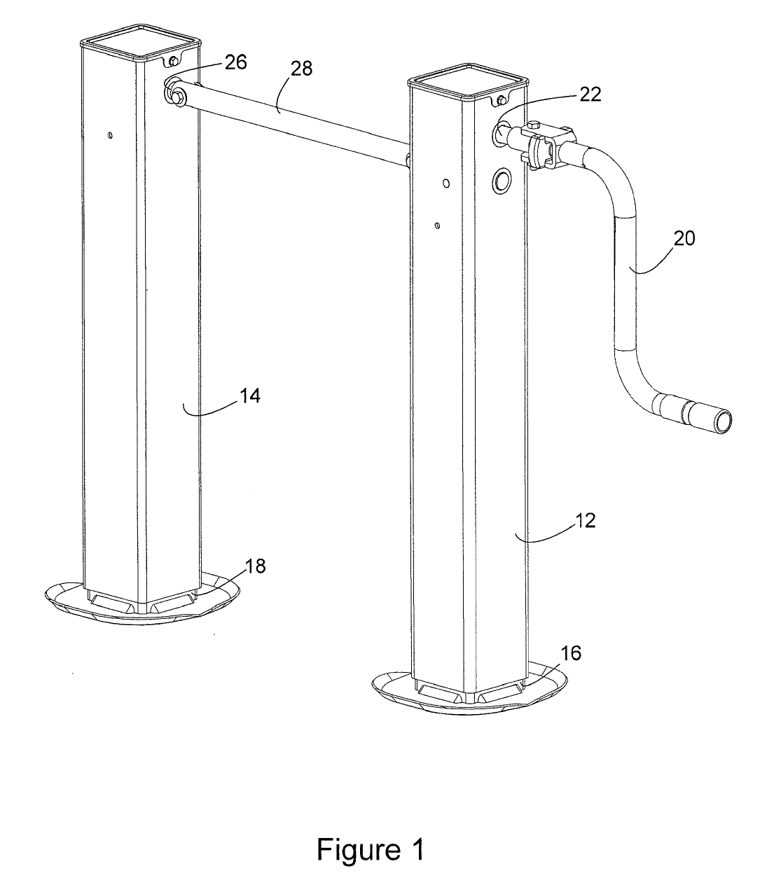

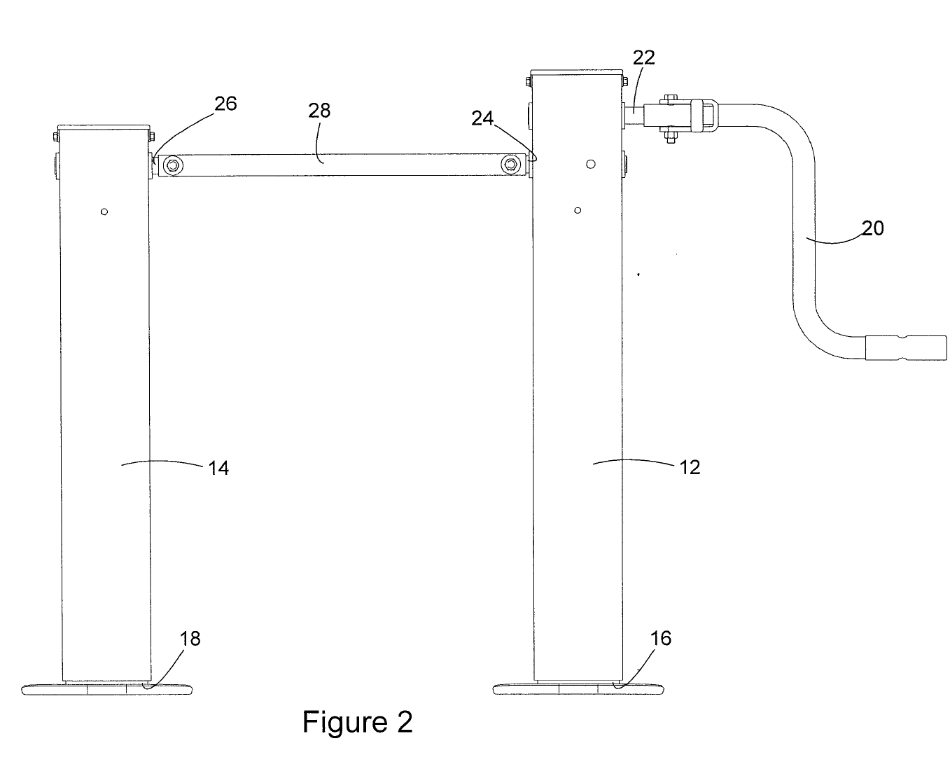

FIGS. 1 and 2 show a pair of landing gear assembly legs removed from a trailer. The legs are shown prepared for attachment by the conventional mount method to the trailer. Each of the legs is contained in a leg enclosure or housing 12, 14. Each leg has a column 16, 18 that is received in a bottom opening of the respective leg housing 12, 14 for telescoping, vertical movement. Manual cranking a hand crank 20 in opposite directions raises and lowers the leg columns 16, 18. An input shaft 22 enters the leg housing 12 commonly referred to as the master leg housing. The input shaft 22 is connected to the hand crank 20. An output shaft 24 extends out of the master leg housing 12 on an opposite side of the housing from the input shaft 22. The input shaft 22 and output shaft 24 are parallel and spaced vertically from each other. A second input shaft 26 extends into the leg housing 14 commonly referred to as the slave leg housing. A cross bar or cross tube 28 connects the master leg output shaft 24 to the slave leg input shaft 26 for rotation of the slave leg input shaft with the master leg output shaft 24. Thus, manual rotation of the master leg input shaft 22 by the hand crank selectively extends the leg columns 16, 18 from their respective leg housings 12, 14 to raise the trailer, or retracts the leg columns 16, 18 into their respective leg housings 12, 14 to lower the trailer.

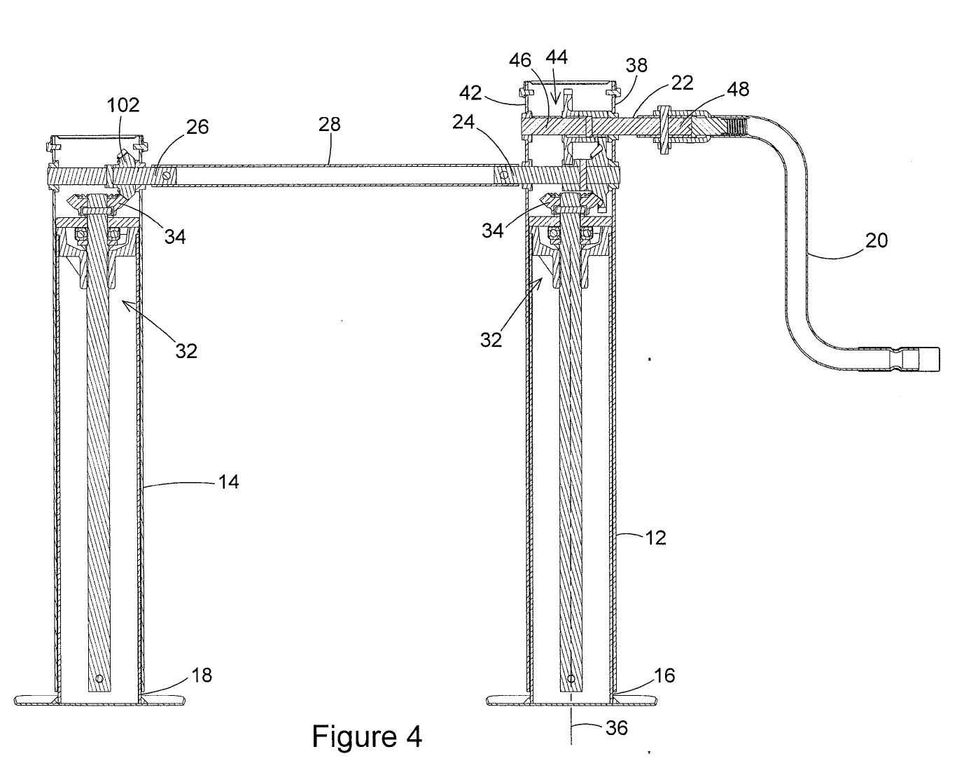

FIG. 4 shows a cross-section view of the master leg gear transmission and slave leg gear transmission of the present invention. The gear transmissions of the invention are designed to provide two gear ratios for adjusting the rates at which the leg columns 16, 18 are extended and retracted relative to their respective leg housings 12, 14. One novel feature of the invention is that the particular gearing configurations of the gear transmission of the invention enables all of the gears of the transmission to be contained inside opposing side walls of the leg housings 12, 14 of the landing gear assembly. Although FIGS. 1, 2, and 4 show the combination of a master leg to the right and a slave leg to the left, the master leg of the invention is designed to be used alone, for example on a goose neck trailer. In such applications the slave leg is not needed.

Referring to FIG. 4, each of the leg housings 12, 14 and their respective leg columns 16, 18 contain a conventional screw and nut actuator assembly 32 operatively connected between each leg housing 12, 14 and its associated leg column 16, 18. The screw and nut actuator assembly 32 comprises an actuator input gear 34. In the embodiment of the actuator shown in the drawing figures, the actuator input gear 34 is a bevel gear having 22 teeth. The actuator input gear 34 is rotated in opposite directions about a center rotation axis 36 to selectively move the leg columns 16, 18 between first, retracted positions and second, extended positions relative to their associated leg housings 12, 14. The leg housings 12, 14 and their respective leg columns 16, 18 together define a length or vertical height of the leg assemblies. The leg columns 16, 18 when moved to their first, retracted positions relative to their associated leg housings 12, 14 define a first, retracted length of the leg assemblies. The leg columns 16, 18 moved to their second, extended positions relative to their associated leg housings 12, 14 define a second, extended length of the leg assemblies. Rotation of the actuator input gear 34 in opposite first and second directions about the gear center axis 36 causes the leg columns 16, 18 to move to their respective first, retracted and second, extended positions relative to their associated leg housings 12, 14. Although a screw and nut actuator assembly 32 is shown in the drawing figures, other types of actuator assemblies that can selectively move the leg columns 16, 18 relative to their associated leg housings 12, 14 may be employed instead of the actuator shown.

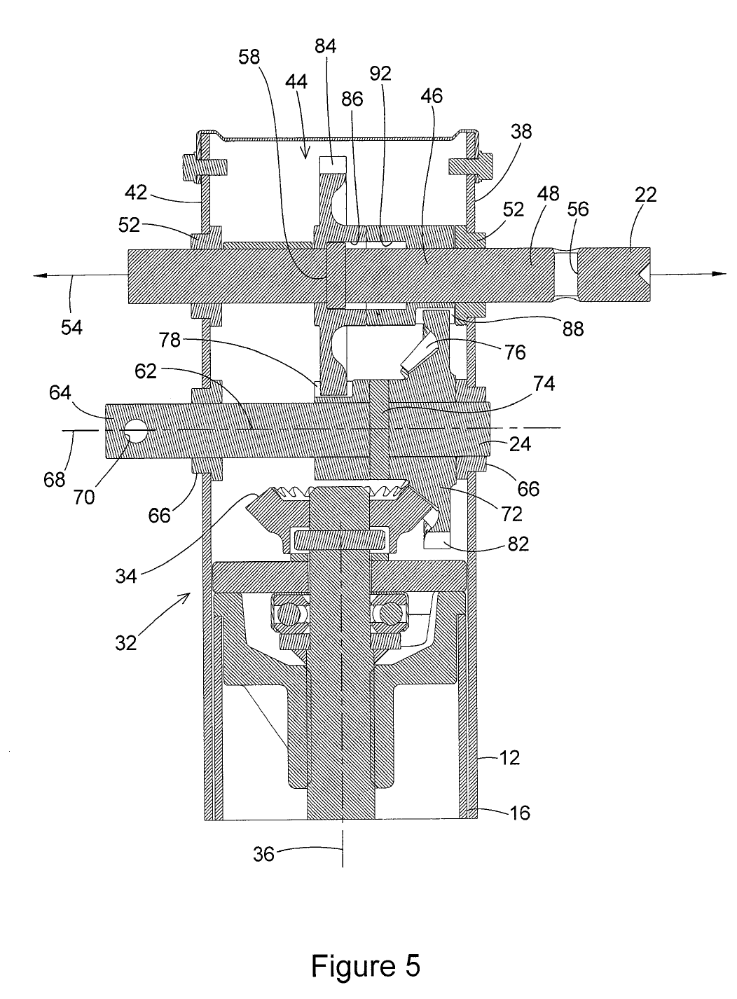

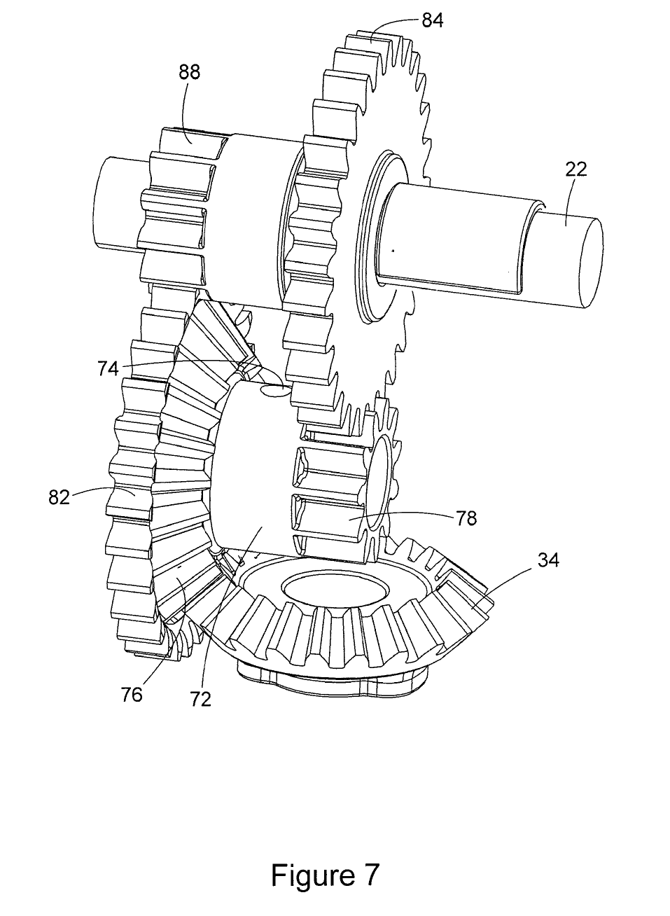

Referring to FIGS. 5-7, the details of the gearing mechanism of the invention can be seen. The gearing mechanism is entirely contained between a pair of first 38 and second 42 opposing sidewalls of the leg housing 12. In the embodiment of the leg assemblies shown in the drawing figures, the leg housing has four sidewalls arranged in a rectangular cross-section configuration. Other configurations of leg housings could be employed with the gearing mechanism of the invention. For example, the first and second sidewalls 38, 42 could each have a half circle configuration. Regardless of the configuration of the leg housing sidewalls, the first 38 and second 42 sidewalls shown in the drawing figures are positioned on opposite sides of the leg housing interior volume 44 enclosing the interior volume and separating the interior volume from the exterior environment of the apparatus.

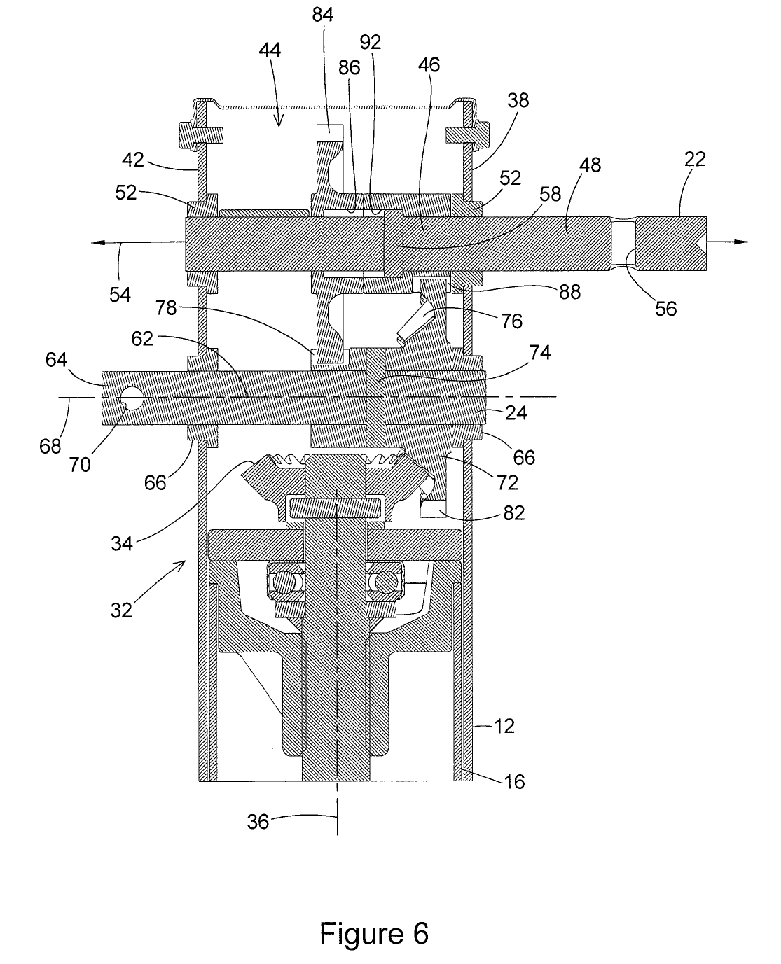

The gear mechanism input shaft 22 has an interior portion 46 that is mounted in the interior volume 44 of the leg housing, and an exterior portion 48 that is positioned outside the leg housing interior volume in the exterior environment of the apparatus. The input shaft interior portion 46 is mounted by a pair of bushings 52 to the first sidewall 38 and second sidewall 42. The bushings 52 allow the input shaft 22 to rotate about a center axis 54 of the input shaft, and move axially along the center axis 54. The input shaft 22 is movable between first and second axially spaced positions relative to the leg housing 12. FIG. 5 shows the input shaft 22 in the first position of the input shaft relative to the leg housing 12, and FIG. 6 shows the input shaft 22 in the second position of the input shaft relative to the leg housing 12. The exterior portion of the input shaft 48 is provided with a means of connecting the input shaft to the manual hand crank 20 shown in FIGS. 1 and 2. The means 56 shown in FIGS. 5 and 6 is a through hole that receives a connecting pin that attaches the input shaft 22 to the hand crank 20.

A clutch mechanism in the form of a shear pin 58 is provided on the interior portion of the input shaft 46. The shear pin 58 is secured to the input shaft interior portion 46 and rotates and moves axially with the input shaft. The pin 58 is mounted in a transverse bore through the input shaft interior portion 46. The pin 58 functions as a key that selectively secures input gears to the input shaft by the axial movement of the input shaft between its first and second positions relative to the leg housing 12, as will be explained.

The output shaft 24 has an interior portion 62 that is also mounted between the first 38 and second 42 sidewalls of the leg housing 12 and an exterior portion 64. A pair of bushings 66 mount the output shaft 24 to the leg housing sidewalls 38, 42 for rotation of the output shaft relative to the leg housing. The output shaft 24 has a center axis 68 that is parallel to the input shaft center axis 54, but is spaced vertically from the input shaft axis. The output shaft 24 does not move axially relative to the leg housing 12 and is held against axial movement by the constructions of the particular bushings 66. The output shaft exterior portion 64 is provided with means for connecting the output shaft to the input shaft 26 of the second, separate landing gear apparatus, such as the slave leg shown to the left in FIGS. 1 and 2. The means for connecting the output shaft exterior portion 64 to the input shaft 26 of the slave leg is a through bore 70 provided in the output shaft exterior portion. The through bore 70 can be used to receive a pin or a threaded fastener that connects the output shaft exterior portion 64 to the cross bar 28 shown in FIGS. 1 and 2.

A gear element 72 is secured stationary on the output shaft 24 for rotation with the output shaft. The gear element 72 is shown secured to the output shaft 24 by a pin 74 inserted through the gear element and through the shaft. Other means of securing the gear element 72 to the output shaft 24 could be employed. The gear element 72 is comprised of three different gears that are formed as one monolithic piece on the gear element 72.

An output gear 76 is formed on the gear element 72. The output gear 76 is a bevel gear that meshes directly with the actuator input gear 34. In the preferred embodiment, the bevel output gear 76 has 20 teeth.

A first driven gear 78 is also formed on the gear element 72. The first driven gear 78 is a spur gear. In the preferred embodiment, the first driven gear 78 has 11 teeth.

A second driven gear 82 is also formed on the gear element 72. The second driven gear 82 is also a spur gear. In the preferred embodiment, the second driven gear 82 has 29 teeth. Each of the output gear 76, the first driven gear 78, and the second driven gear 82 are formed as one piece on the gear element 72 and are all secured stationary to the output shaft 24 inside the leg housing interior volume 44 for rotation of the gears with the output shaft.

A first drive gear 84 is mounted for rotation on the input shaft 22 inside the leg housing interior volume 44. The first drive gear 84 is a spur gear that meshes directly with the first driven gear 78 on the output shaft 24. In the preferred embodiment, the first drive gear 84 has 29 teeth. The first drive gear 84 is provided with one or more interior slots 86 in an end face of the gear. The slots 86 are dimensioned to receive the key clutch member 58 on the input shaft 22 when the input shaft is moved to its first position relative to the leg housing 12. This position of the clutch mechanism 58 is shown in FIG. 5. With the clutch mechanism key 58 inserted into the first drive gear slot 86, the first drive gear 84 is secured to the input shaft 22 for rotation of the drive gear with the input shaft. When the input shaft 22 is moved to its second axial position relative to the leg housing 12, the clutch mechanism pin 58 is withdrawn out of the first drive gear slot 86 and the first drive gear 84 is free to rotate relative to the input shaft 22.

A second drive gear 88 is mounted on the input shaft 22 for rotation of the second drive gear relative to the input shaft. The second drive gear 88 is a spur gear that meshes directly with the second driven gear 82. In the preferred embodiment, the second drive gear 88 has 11 teeth. The second drive gear 88 is also provided with one or more slots 92 that extend axially into an end face of the gear. The slots 92 are in an end face of the second drive gear 88 that opposes the end face of the first drive gear 84 having the slots 86. The slots 92 in the second drive gear 88 are also dimensioned to receive the clutch mechanism pin 58 when the input shaft 22 is moved to its second axial position relative to the leg housing 12. Receipt of the clutch mechanism pin 58 in the second drive gear slot 92 secures the second drive gear 88 to the input shaft 22 for rotation of the gear with the shaft. When the input shaft 22 is moved to its first axial position relative to the leg housing 12, the clutch mechanism pin 58 is withdrawn out of the second drive gear slot 92 and the second drive gear 88 is free to rotate on the input shaft 22.

The second input shaft 26 of the second leg housing 14 is mounted by a pair of bushings 96 between a first sidewall 98 and a second sidewall 102 of the housing. The bushings 96 mount the second input shaft 26 for rotation in the second leg housing 14, and hold the input shaft against axial movement. The second input shaft 26 is operatively connected to the output shaft 24 by the cross bar 28. Thus, the second input shaft 26 rotates with the output shaft 24.

An additional drive gear 102 is secured to the second input shaft 26 for rotation with the second input shaft. The additional drive gear 102 is a bevel gear that meshes directly with the actuator input gear 34 in the second leg housing 14. The additional drive gear 102 has the same number of teeth as the output gear 76. Thus, rotation of the output shaft 24 causes the screw and nut actuator assemblies 32 in each of the leg housings 12, 14 to simultaneously move their respective leg columns 16, 18 between their retracted and extended positions relative to the leg housings, depending on the direction of rotation of the input shaft 22.

In operation of the gear transmission of the invention, with the input shaft 22 of the master leg housing 12 in the first, high speed position shown in FIG. 5, rotation of the input shaft 22 by a manual crank 20 causes rotation of the first, high speed drive gear 84. The constant mesh of the first drive gear 84 with the first driven gear 78 causes the high speed rotation of the output bevel gear 76. Rotation of the output bevel gear 76 causes the bevel actuator input gear 34 of the screw and nut linear actuator assembly 32 to rotate. This causes the vertical reciprocating movement of the leg column 16 in the leg housing 12. In addition, the rotation of the first driven gear 78 and output bevel gear 76 is transferred through the output shaft 24 of the master leg housing 12 to the input shaft 26 of the slave leg housing 14. The rotation of the input shaft 26 of the slave leg housing is transferred by the bevel additional gear 102 on the input shaft 26 to the bevel actuator input gear 34 of the screw and nut linear actuator assembly 32 in the slave leg housing 14. This causes the vertical reciprocating movement of the leg column 18 in the leg housing 14.

In the high speed position of the input shaft 22 described above, the vertical adjustments of the leg columns 16, 18 in their respective leg housing 12, 14 occur more quickly.

To shift the gear transmission to low speed operation, the input shaft 22 of the master leg housing 12 is pulled outwardly, causing the shear pin 58 to move out of the slots 86 of the first drive gear, and into the slots 92 of the second drive gear 88. This couples the second, low speed drive gear 88 to the input shaft 22 for rotation with the input shaft. The rotation of the low speed second drive gear 88 is transferred through the second driven gear 82 to the output gear 76. Rotation of the output gear 76 causes the vertical reciprocating movements of the leg columns 16, 18 in their respective leg housings 12, 14 in the same manner discussed above. However, because the second drive gear 88 has fewer teeth than the first drive gear 84, the vertical adjusting movements of the leg columns 16, 18 in their respective leg housings 12, 14 do not occur as quickly as when the transmission is operated in high speed, but greater torque is provided for lifting the trailer.

The novel design of the landing gear assembly gear transmission described above allows all of the gearing of the transmission to be contained in the same master leg housing 12 that contains the screw and nut vertical actuator for the leg. As seen in FIG. 5, all of the gearing of the transmission is contained in the leg housing 12 positioned directly above the screw and nut actuator assembly 32. All of the shaft center axes 36, 54, 68 are positioned in the same plane. This provides the landing gear assembly of the invention with a more compact construction than prior art landing gear assemblies which required a separate gear box on the exterior of the leg housing, or a separate bolt-on shaft support housing on the exterior of the leg housing. Thus, the gear transmission of the present invention provides a simplified constant mesh design of a two-speed landing gear transmission that does not require a separate gear box or separate shaft housing, and is contained in the same leg housing as the screw and nut actuator assembly of the landing gear assembly leg.

Although only one embodiment of the landing gear assembly has been described above, it should be understood that other modifications and variations could be made to the landing gear assembly without departing from the scope of the invention defined by the following claims.

What is claimed is:

1. A landing gear apparatus for supporting a trailer, the apparatus comprising:
a leg housing having an interior volume and at least first and second sidewalls on opposite sides of the interior volume;
a leg column that is connected to the leg housing, the leg column being movable relative to the leg housing between a first, retracted position of the leg column relative to the leg housing, and a second, extended position of the leg column relative to the leg housing;
an actuator assembly inside the leg housing interior volume and operatively connected to the leg housing and the leg column, the actuator assembly having an actuator input gear that is rotatable in opposite first and second directions about a center axis of the actuator input gear to cause the leg column to move to the respective first, retracted and second, extended positions of the leg column relative to the leg housing;
an input shaft mounted to the first and second sidewalls of the leg housing, the input shaft having a center axis and being rotatable about the center axis relative to the leg housing and being movable axially along the center axis between first and second positions of the input shaft relative to the leg housing;
an output shaft mounted to the first and second sidewalls of the leg housing, the output shaft having a center axis and being rotatable about the output shaft center axis relative to the leg housing, the output shaft having means for connecting the output shaft to an input shaft of a second, separate landing gear apparatus;
an output gear secured stationary to the output shaft inside the leg housing interior volume for rotation of the output gear with the output shaft, the output gear meshing directly with the actuator input gear;
a first driven gear secured stationary to the output shaft inside the leg housing interior volume for rotation of the first driven gear with the output shaft, the first driven gear having a first number of driven gear teeth;
a second driven gear secured stationary to the output shaft inside the leg housing interior volume for rotation of the second driven gear with the output shaft, the second driven gear having a second number of driven gear teeth;
a first drive gear mounted on the input shaft inside the leg housing interior volume for rotation of the first drive gear relative to the input shaft, the first drive gear having a first number of drive gear teeth that mesh directly with the first number of driven gear teeth;
a second drive gear mounted on the input shaft inside the leg housing interior volume for rotation of the second drive gear relative to the input shaft, the second drive gear having a second number of drive gear teeth that mesh directly with the second number of driven gear teeth;
the actuator input gear, the output gear, the first driven gear, the second driven gear, the first drive gear, and the second drive gear being the only gears inside the interior volume of the leg housing; and,
a clutch mechanism on the input shaft inside the leg housing interior volume for rotation of the clutch mechanism with rotation of the input shaft and axial movement of the clutch mechanism between first and second axially spaced positions of the clutch mechanism relative to the leg housing in response to the input shaft moving between the respective first and second positions of the input shaft relative to the leg housing, where in the first position of the clutch mechanism the clutch mechanism secures the first drive gear stationary to the input shaft for rotation of the first drive gear with rotation of the input shaft, and in the second position of the clutch mechanism the clutch mechanism secures the second drive gear stationary to the input shaft for rotation of the second drive gear with rotation of the input shaft.

2. The apparatus of claim 1, further comprising:
a second leg housing having an interior volume and at least first and second sidewalls on opposite sides of the second leg housing interior volume;
a second leg column that is connected to the second leg housing and is movable relative to the second leg housing between a first, retracted position and a second, extended position of the second leg column relative to the second leg housing;
a second actuator assembly inside the second leg housing interior volume and operatively connected to the second leg housing and the second leg column, the second actuator assembly having a second actuator input gear that is rotatable in opposite first and second directions about a center axis of the second actuator input gear to cause the second leg column to move to the respective first, retracted position and the second, extended position of the second leg column relative to the second leg housing;
a second input shaft mounted to the first and second sidewalls of the second leg housing, the second input shaft being rotatable relative to the second leg housing and being operatively connected to the means for connecting the output shaft to an input shaft of a second, separate landing gear apparatus for rotation of the second input shaft with rotation of the output shaft; and,
a gear mechanism inside the interior volume of the second leg housing operatively connecting the second input shaft with the second actuator input gear for rotation of the second actuator input gear with rotation of the second input shaft.

3. The apparatus of claim 1, further comprising:
the output shaft and the input shaft being the only shafts mounted to the first and second sidewalls of the leg housing.

4. The apparatus of claim 1, further comprising:
the actuator input gear and the output gear being bevel gears and the first and second driven gears and first and second drive gears being spur gears.

5. The apparatus of claim 1, further comprising:
the output gear and the first and second driven gears being on a one-piece gear element that is secured stationary to the output shaft.

6. The apparatus of claim 1, further comprising:
the input shaft having an exterior portion outside of the leg housing interior volume, the input shaft exterior portion having means for connecting the input shaft to a manual crank.

7. The apparatus of claim 1, further comprising:
the second number of driven gear teeth being more than the first number of driven gear teeth; and,
the second number of drive gear teeth being less than the first number of drive gear teeth.

8. A landing gear apparatus for supporting a trailer, the apparatus comprising:
a leg housing having an interior volume and at least first and second sidewalls on opposite sides of the interior volume;
a leg column that is connected to the leg housing, the leg column being movable relative to the leg housing between a first, retracted position of the leg column relative to the leg housing, and a second, extended position of the leg column relative to the leg housing;
an actuator assembly inside the leg housing interior volume and operatively connected to the leg housing and the leg column, the actuator assembly having an actuator input gear that is rotatable in opposite first and second directions about a center axis of the actuator input gear to cause the leg column to move to the respective first, retracted and second, extended positions of the leg column relative to the leg housing;
an input shaft mounted to the first and second sidewalls of the leg housing, the input shaft having a center axis and being rotatable about the center axis relative to the leg housing and being movable axially along the center axis between first and second positions of the input shaft relative to the leg housing;
an output shaft mounted to the first and second sidewalls of the leg housing, the output shaft having a center axis and being rotatable about the output shaft center axis relative to the leg housing, the output shaft having means for connecting the output shaft to an input shaft of a second, separate landing gear apparatus;
the input shaft and the output shaft being the only shafts mounted to the first and second sidewalls of the leg housing;
an output gear secured stationary to the output shaft inside the leg housing interior volume for rotation of the output gear with the output shaft, the output gear meshing directly with the actuator input gear;
a first driven gear secured stationary to the output shaft inside the leg housing interior volume for rotation of the first driven gear with the output shaft, the first driven gear having a first number of driven gear teeth;
a second driven gear secured stationary to the output shaft inside the leg housing interior volume for rotation of the second driven gear with the output shaft, the second driven gear having a second number of driven gear teeth;
a first drive gear mounted on the input shaft inside the leg housing interior volume for rotation of the first drive gear relative to the input shaft, the first drive gear having a first number of drive gear teeth that mesh directly with the first number of driven gear teeth;
a second drive gear mounted on the input shaft inside the leg housing interior volume for rotation of the second drive gear relative to the input shaft, the second drive gear having a second number of drive gear teeth that mesh directly with the second number of driven gear teeth; and,
a clutch mechanism on the input shaft inside the leg housing interior volume for rotation of the clutch mechanism with rotation of the input shaft and axial movement of the clutch mechanism between first and second axially spaced positions of the clutch mechanism relative to the leg housing in response to the input shaft moving between the respective first and second positions of the input shaft relative to the leg housing, where in the first position of the clutch mechanism the clutch mechanism secures the first drive gear stationary to the input shaft for rotation of the first drive gear with rotation of the input shaft, and in the second position of the clutch mechanism the clutch mechanism secures the second drive gear stationary to the input shaft for rotation of the second drive gear with rotation of the input shaft.

9. The apparatus of claim 8, further comprising:
a second leg housing having an interior volume and at least first and second sidewalls on opposite sides of the second leg housing interior volume;
a second leg column that is connected to the second leg housing and is movable relative to the second leg housing between a first, retracted position and a second, extended position of the second leg column relative to the second leg housing;
a second actuator assembly inside the second leg housing interior volume and operatively connected to the second leg housing and the second leg column, the second actuator assembly having a second actuator input gear that is rotatable in opposite first and second directions about a center axis of the second actuator input gear to cause the second leg column to move to the respective first, retracted position and the second, extended position of the second leg column relative to the second leg housing;
a second input shaft mounted to the first and second sidewalls of the second leg housing, the second input shaft being rotatable relative to the second leg housing and being operatively connected to the means for connecting the output shaft to an input shaft of a second, separate landing gear apparatus for rotation of the second input shaft with rotation of the output shaft; and,
a gear mechanism inside the interior volume of the second leg housing operatively connecting the second input shaft with the second actuator input gear for rotation of the second actuator input gear with rotation of the second input shaft.

10. The apparatus of claim 8, further comprising:
the actuator input gear, the output gear, the first driven gear, the second driven gear, the first drive gear, and the second drive gear being the only gears inside the interior volume of the leg housing between the first and second sidewalls.

11. The apparatus of claim 8, further comprising:
the actuator input gear and the output gear being bevel gears and the first and second driven gears and first and second drive gears being spur gears.

12. The apparatus of claim 8, further comprising:
the output gear and the first and second driven gears being on a one-piece gear element that is secured stationary to the output shaft.

13. The apparatus of claim 8, further comprising:
the output shaft being held stationary against axial movement along the output shaft center axis relative to the leg housing.

14. The apparatus of claim 8, further comprising:
the second number of driven gear teeth being more than the first number of driven gear teeth; and,
the second number of drive gear teeth being less than the first number of drive gear teeth.

15. A landing gear apparatus for supporting a trailer, the apparatus comprising:
a leg housing having an interior volume and at least first and second sidewalls on opposite sides of the interior volume;
a leg column that is connected to the leg housing, the leg column being movable relative to the leg housing between a first, retracted position of the leg column relative to the leg housing, and a second, extended position of the leg column relative to the leg housing;
an actuator assembly inside the leg housing interior volume and operatively connected to the leg housing and the leg column, the actuator assembly having an actuator input gear that is rotatable in opposite first and second directions about a center axis of the actuator input gear to cause the leg column to move to the respective first, retracted and second, extended positions of the leg column relative to the leg housing;
an input shaft mounted to the first and second sidewalls of the leg housing, the input shaft having a center axis and being rotatable about the center axis relative to the leg housing and being movable axially along the center axis between first and second positions of the input shaft relative to the leg housing;
an output shaft mounted to the first and second sidewalls of the leg housing, the output shaft having a center axis and being rotatable about the output shaft center axis relative to the leg housing, the output shaft having means for connecting the output shaft to an input shaft of a second, separate landing gear apparatus;
an output gear secured stationary to the output shaft inside the leg housing interior volume for rotation of the output gear with the output shaft, the output gear meshing directly with the actuator input gear;
a first driven gear secured stationary to the output shaft inside the leg housing interior volume for rotation of the first driven gear with the output shaft, the first driven gear having a first number of driven gear teeth;
a second driven gear secured stationary to the output shaft inside the leg housing interior volume for rotation of the second driven gear with the output shaft, the second driven gear having a second number of driven gear teeth;
a first drive gear mounted on the input shaft inside the leg housing interior volume for rotation of the first drive gear relative to the input shaft, the first drive gear having a first number of drive gear teeth that mesh directly with the first number of driven gear teeth;
a second drive gear mounted on the input shaft inside the leg housing interior volume for rotation of the second drive gear relative to the input shaft, the second drive gear having a second number of drive gear teeth that mesh directly with the second number of driven gear teeth;
the output gear, the first driven gear, and the second driven gear all being on a one-piece, monolithic gear element that is secured to the output shaft; and,
a clutch mechanism on the input shaft inside the leg housing interior volume for rotation of the clutch mechanism with rotation of the input shaft and axial movement of the clutch mechanism between first and second axially spaced positions of the clutch mechanism relative to the leg housing in response to the input shaft moving between the respective first and second positions of the input shaft relative to the leg housing, where in the first position of the clutch mechanism the clutch mechanism secures the first drive gear stationary to the input shaft for rotation of the first drive gear with rotation of the input shaft, and in the second position of the clutch mechanism the clutch mechanism secures the second drive gear stationary to the input shaft for rotation of the second drive gear with rotation of the input shaft.

16. The apparatus of claim 15, further comprising:
a second leg housing having an interior volume and at least first and second sidewalls on opposite sides of the second leg housing interior volume that enclose the second leg housing interior volume;
a second leg column that is connected to the second leg housing and is movable relative to the second leg housing between a first, retracted position and a second, extended position of the second leg column relative to the second leg housing;
a second actuator assembly inside the second leg housing interior volume and operatively connected to the second leg housing and the second leg column, the second actuator assembly having a second actuator input gear that is rotatable in opposite first and second directions about a center axis of the second actuator input gear to cause the second leg column to move to the respective first, retracted position and the second, extended position of the second leg column relative to the second leg housing;
a second input shaft mounted to the first and second sidewalls of the second leg housing, the second input shaft being rotatable relative to the second leg housing and being operatively connected to the means for connecting the output shaft to an input shaft of a second, separate landing gear apparatus for rotation of the second input shaft with rotation of the output shaft; and,
a gear mechanism inside the interior volume of the second leg housing operatively connecting the second input shaft with the second actuator input gear for rotation of the second actuator input gear with rotation of the second input shaft.

17. The apparatus of claim 15, further comprising:
the actuator input gear, the output gear, the first driven gear, the second driven gear, the first drive gear, and the second drive gear being the only gears inside the interior volume of the leg housing between the first and second sidewalls.

18. The apparatus of claim 15, further comprising:
the output shaft and the input shaft being the only shafts mounted to the first and second sidewalls of the leg housing.

19. The apparatus of claim 15, further comprising:
the actuator input gear and the output gear being bevel gears and the first and second driven gears and first and second drive gears being spur gears.

20. A landing gear apparatus for supporting a trailer, the apparatus comprising:
a leg housing having an interior volume and at least first and second sidewalls on opposite sides of the interior volume that enclose the interior volume and separate the interior volume from an exterior environment of the apparatus;
a leg column that is connected to the leg housing and together with the leg housing define a length of the apparatus, the leg column being movable relative to the leg housing between a first, retracted position of the leg column relative to the leg housing that defines a first, retracted length of the apparatus, and a second, extended position of the leg column relative to the leg housing that defines a second, extended length of the apparatus, with the extended length of the apparatus being larger than the retracted length of the apparatus;
an actuator assembly inside the leg housing interior volume and operatively connected to the leg housing and the leg column, the actuator assembly having an actuator input gear that is rotatable in opposite first and second directions about a center axis of the actuator input gear to cause the leg column to move to the respective first, retracted and second, extended positions of the leg column relative to the leg housing;
an input shaft mounted to the first and second sidewalls of the leg housing with an interior portion of the input shaft positioned in the leg housing interior volume and an exterior portion of the input shaft positioned outside the leg housing interior volume in the exterior environment of the apparatus, the input shaft having a center axis and being rotatable about the center axis relative to the leg housing and being movable axially along the center axis between first and second positions of the input shaft relative to the leg housing, the input shaft exterior portion having means for connecting the input shaft to a manual crank;
an output shaft mounted to the first and second sidewalls of the leg housing with an interior portion of the output shaft positioned in the leg housing interior volume and an exterior portion of the output shaft positioned outside the leg housing interior volume in the exterior environment of the apparatus, the output shaft having a center axis and being rotatable about the output shaft center axis relative to the leg housing and being held stationary against axial movement along the output shaft center axis, the output shaft exterior portion having means for connecting the output shaft to an input shaft of a second, separate landing gear apparatus;
the actuator input gear center axis, the input shaft center axis, and the output shaft center axis all being positioned in a single plane;
an output gear secured stationary to the output shaft inside the leg housing interior volume for rotation of the output gear with the output shaft, the output gear meshing directly with the actuator input gear;
a first driven gear secured stationary to the output shaft inside the leg housing interior volume for rotation of the first driven gear with the output shaft, the first driven gear having a first number of driven gear teeth;
a second driven gear secured stationary to the output shaft inside the leg housing interior volume for rotation of the second driven gear with the output shaft, the second driven gear having a second number of driven gear teeth that is more than the first number of driven gear teeth;
a first drive gear mounted on the input shaft inside the leg housing interior volume for rotation of the first drive gear relative to the input shaft, the first drive gear having a first number of drive gear teeth that mesh directly with the first number of driven gear teeth;
a second drive gear mounted on the input shaft inside the leg housing interior volume for rotation of the second drive gear relative to the input shaft, the second drive gear having a second number of drive gear teeth that mesh directly with the second number of driven gear teeth the second number of drive gear teeth being less than the first number of drive gear teeth; and,
a clutch mechanism on the input shaft inside the leg housing interior volume for rotation of the clutch mechanism with rotation of the input shaft and axial movement of the clutch mechanism between first and second axially spaced positions of the clutch mechanism relative to the leg housing in response to the input shaft moving between the respective first and second positions of the input shaft relative to the leg housing, where in the first position of the clutch mechanism the clutch mechanism secures the first drive gear stationary to the input shaft for rotation of the first drive gear with rotation of the input shaft, and in the second position of the clutch mechanism the clutch mechanism secures the second drive gear stationary to the input shaft for rotation of the second drive gear with rotation of the input shaft.

21. The apparatus of claim 20, further comprising:
a second leg housing having an interior volume and at least first and second sidewalls on opposite sides of the second leg housing interior volume that enclose the second leg housing interior volume;
a second leg column that is connected to the second leg housing and is movable relative to the second leg housing between a first, retracted position and a second, extended position of the second leg column relative to the second leg housing;
a second actuator inside the second leg housing interior volume and operatively connected to the second leg housing and the second leg column, the second actuator assembly having a second actuator input gear that is rotatable in opposite first and second directions about a center axis of the second actuator input gear to cause the second leg column to move to the respective first, retracted position and the second, extended position of the second leg column relative to the second leg housing;
a second input shaft mounted to the first and second sidewalls of the second leg housing, the second input shaft being rotatable relative to the second leg housing and being operatively connected to the means for connecting the output shaft to an input shaft of a second, separate landing gear apparatus for rotation of the second input shaft with rotation of the output shaft; and,
a gear mechanism inside the interior volume of the second leg housing operatively connecting the second input shaft with the second actuator input gear for rotation of the second actuator input gear with rotation of the second input shaft.

22. The apparatus of claim 20, further comprising:
the actuator input gear, the output gear, the first driven gear, the second driven gear, the first drive gear, and the second drive gear being the only gears inside the interior volume of the leg housing between the first and second sidewalls.

23. The apparatus of claim 20, further comprising:
the output shaft and the input shaft being the only shafts mounted to the first and second sidewalls of the leg housing.

24. The apparatus of claim 20, further comprising:
the actuator input gear and the output gear being bevel gears and the first and second driven gears and first and second drive gears being spur gears.

25. The apparatus of claim 20, further comprising:
the output gear and the first and second driven gears being on a one-piece gear element that is secured stationary to the output shaft.
